(19) United States
(12) Patent Application Publication
(10) Pub. No.: US 2005/0144307 A1
(43) Pub. Date: Jun. 30, 2005

(54) Back-end alignment to avoid SDMA ACK time-out

(76) Inventors: Qinghua Li, Sunnyvale, CA (US); Xintian E. Lin, Mountain View, CA (US); Minnie Ho, Los Altos, CA (US); Adrian P. Stephens, Cambridge (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/737,142

(22) Filed: Dec. 15, 2003

(51) Int. Cl. G06F 15/16

(52) U.S. Cl. 709/232

(57) ABSTRACT

In a base station using spatial division multiple access communications, different length transmissions directed from a base station to different multiple mobile devices substantially simultaneously may have their start times adjusted so that the transmissions end at approximately the same time. The mobile devices may then respond during a response period with acknowledgments at approximately the same time. Thus all the acknowledgments may be received within the same time period from the end of the transmissions, reducing the likelihood of missed acknowledgments in responses to the shorter transmissions.

### BACKGROUND

To address the problem of ever-increasing bandwidth requirements that are placed on wireless data communications systems, various techniques are being developed to allow multiple devices to communicate with a single base station by sharing a single channel. In one such technique, a base station may transmit or receive separate signals to or from multiple mobile devices at the same time on the same frequency, provided the mobile devices are located in sufficiently different directions from the base station. For transmission from the base station, different signals may be simultaneously transmitted from each of separate spaced-apart antennas so that the combined transmissions are directional, i.e., the signal intended for each mobile device may be relatively strong in the direction of that mobile device and relatively weak in other directions. In a similar manner, the base station may receive the combined signals from multiple independent mobile devices at the same time on the same frequency through each of separate spaced-apart antennas, and separate the combined received signals from the multiple antennas into the separate signals from each mobile device through appropriate signal processing so that the reception is directional.

Under currently developing specifications, such as IEEE 802.11 (IEEE is the acronym for the Institute of Electrical and Electronic Engineers, 3 Park Avenue, 17th floor, New York, N.Y.), a base station may transmit different variable-length blocks to different mobile devices at substantially the same time, and then wait for the designated mobile devices to respond with acknowledgments, with each acknowledgment signifying that the respective mobile device received the block. Because each mobile device may respond shortly after it receives its designated transmission from the base station, a mobile device that receives a short block may send its response while the base station is still transmitting a longer block to a different mobile device. If the base station transmits and receives on the same frequency and therefore cannot transmit and receive at the same time, the acknowledgment to the short block may be missed because the base station is still transmitting. The base station may then assume the short data block was never received by the intended mobile device and subsequently retransmit it. This unnecessary retransmission may cause inefficiencies in the overall data communications, and under some circumstances may even result in a service interruption.

### BRIEF DESCRIPTION OF THE DRAWINGS

The invention may be understood by referring to the following description and accompanying drawings that are used to illustrate embodiments of the invention. In the drawings:

FIG. 1 shows a diagram of a communications network, according to an embodiment of the invention.

FIG. 2 shows a timing diagram of a communications sequence involving a base station and multiple mobile devices, according to an embodiment of the invention.

FIG. 3 shows a flow chart of a method of adjusting transmissions to end at approximately the same time, according to an embodiment of the invention.

FIG. 4 shows a block diagram of a base station, according to an embodiment of the invention.

### DETAILED DESCRIPTION OF THE INVENTION

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

In keeping with common industry terminology, the terms “base station”, “access point”, and “AP” may be used interchangeably herein to describe an electronic device that may communicate wirelessly and substantially simultaneously with multiple other electronic devices, while the terms “mobile device” and “STA” may be used interchangeably to describe any of those multiple other electronic devices, which may have the capability to be moved and still communicate, though movement is not a requirement. However, the scope of the invention is not limited to devices that are labeled with those terms. Similarly, the terms “spatial division multiple access” and SDMA may be used interchangeably. As used herein, these terms are intended to encompass any communication technique in which different signals may be transmitted by a combination of antennas substantially simultaneously from the same device such that the combined transmitted signals result in different signals intended for different devices being transmitted substantially in different directions on the same frequency, and/or techniques in which different signals may be received substantially simultaneously through multiple antennas on the same frequency from different devices in different directions and the different signals may be separated from each other through suitable processing. The term “same frequency”, as used herein, may include slight variations in the exact frequency due to such things as bandwidth tolerance, Doppler shift adaptations, parameter drift, etc. Two or more transmissions to different devices are considered substantially simultaneous if at least a portion of each transmission to the different devices occurs at the same time, but does not imply that the different transmissions must start and/or end at the same time, although they may. Similarly, two or more receptions from different devices are considered substantially simultaneous if at least a portion of each reception from the different devices occurs at the same time, but does not imply that the different transmissions must start and/or end at the same time, although they may. Variations of the words represented by the term SDMA may sometimes be used by others, such as but not limited to substituting “space” for “spatial”, or “diversity” for “division”. The scope of various embodiments of the invention is intended to encompass such differences in nomenclature.

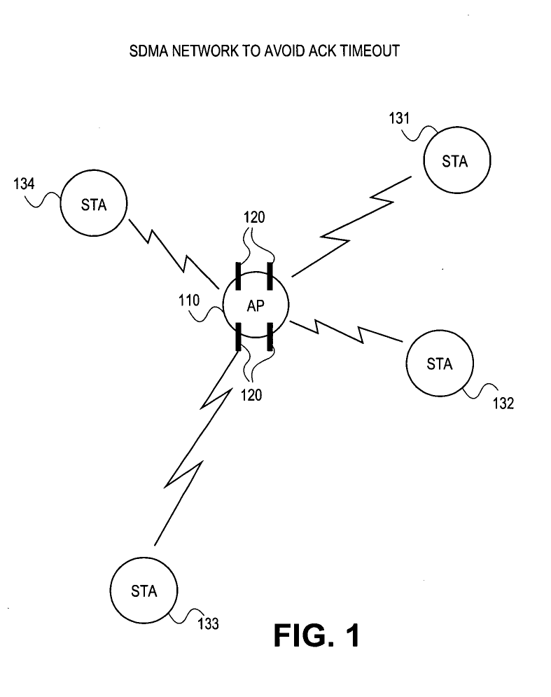

FIG. 1 shows a diagram of a communications network, according to an embodiment of the invention. The illustrated embodiment of an SDMA-based network shows an AP 110 that may communicate with multiple STAs 131-134 located in different directions from the AP, while avoiding acknowledgment timeouts associated with sending different length transmissions to the different STAs. Although AP 110 is shown with four antennas 120 to simultaneously communicate with up to four STAs at a time, other embodiments may have other arrangements (e.g., AP 110 may have two, three, or more than four antennas). Each STA may have one or more antennas to communicate with the AP 110. In some embodiments the one or more STA antennas may be adapted to operate as omnidirectional antennas, but in other embodiments the one or more STA antennas may be adapted to operate as directional antennas. In some embodiments the STAs may be in fixed locations, but in other embodiments at least some of the STAs may be moving during and/or between the communication sequences. In some embodiments the AP 110 may be in a fixed location, but in other embodiments the AP 110 may be mobile.

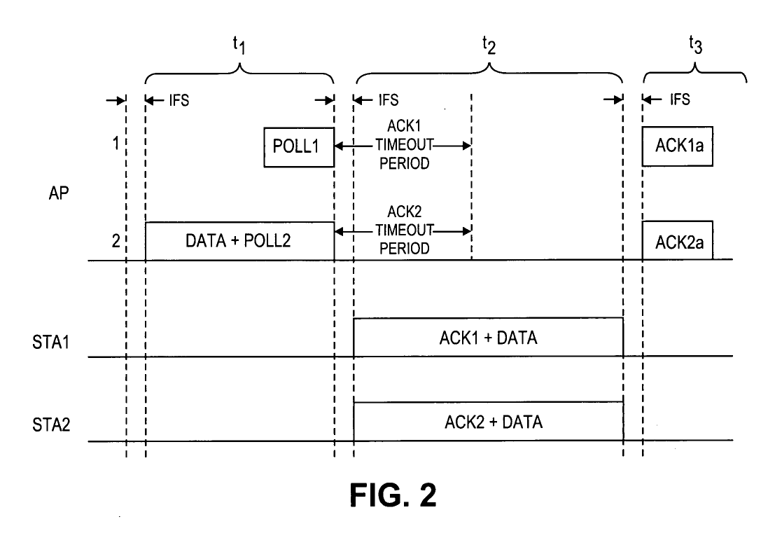

FIG. 2 shows a timing diagram of a communications sequence involving an AP and two STAs (labeled STA1 and STA2), according to an embodiment of the invention. Although the illustrated embodiment only shows two STAs, other embodiments may comprise other quantities of STAs. In the AP section of FIG. 2, the line labeled 1 indicates directional transmissions from the AP to STA1, while the line labeled 2 indicates directional transmissions from the AP to STA2. The lines STA1 and STA2 indicate transmissions from STA1 to the AP and from STA2 to the AP, respectively. In some embodiments, transmissions from STA1 and STA2 may be nominally omnidirectional (e.g., no direction is intentionally favored—reception within a 360 degree circle around the STA is intended), although in other embodiments the transmissions from STA1 and STA2 may be directional.

Communications between the AP and the STAs may include other communications sequences not shown in FIG. 2, e.g., communications that occur before and/or after the sequences shown. Such sequences may include, but are not limited to, such things as training (communications to derive parameters needed to enable SDMA techniques), poll (request to respond), data (substantive information), acknowledgment (verification that a previous transmission was correctly received), etc.

In FIG. 2, it may be assumed that the AP has already established whatever SDMA parameters may be needed to transmit different data to multiple STAs substantially simultaneously, and to receive different data from multiple STAs substantially simultaneously. Using this capability, the AP may transmit to both STA1 and STA2 during time period t1. In the embodiment shown, the AP transmits a poll (POLL1) to STA1, requesting a response including data (if any data is available) and an acknowledgment (ACK1) to the POLL1 from STA1. Similarly, the AP transmits a poll (POLL2) to STA2 substantially simultaneously with the poll to STA1, requesting a response including data (if any data is available) and an acknowledgment (ACK2) to the POLL2 from STA2. In the illustrated embodiment of FIG. 2, the AP also transmits data to STA2 in addition to POLL2, causing the transmission to STA2 to be longer than the transmission to STA1. If the transmissions to both STAs were to start at the same time, the transmission to STA1 might end sooner than the transmission to STA2, and the immediate response from STA1 might not be received by the AP because the AP would still be transmitting to STA2 during that response. The AP might subsequently begin listening for the response from STA1, but never receive the response because it had been transmitted too soon.

To avoid such time-out conditions, the start of the transmission to STA1 may be delayed for a predetermined time so that the transmissions to STA1 and STA2 both end at approximately the same time, as shown in FIG. 2. Thus, both STA1 and STA2 may respond within a prescribed time after their respective polls and avoid time-out issues, even though the prescribed time may be substantially shorter than the possible difference in the durations of the transmissions from STA1 and STA2. The illustrated embodiment shows separate timeout periods for each STA that is polled, and the separate timeout periods may have the same or different durations (the same durations are shown). Alternately, a single timeout period may be maintained within which all polled STAs are expected to send an acknowledgment. The illustrated embodiment also shows acknowledgment timeout periods that are shorter than the response period t₂, during which a given STA may deliver an acknowledgment within the timeout period that is separately verifiable from the remaining response (e.g., the acknowledgment may be verified as correctly received by the AP even if the remainder of the response becomes corrupted), but other embodiments may use other techniques (e.g., the acknowledgement timeout period may be as long or longer than time period t₂, the beginning of any response may be interpreted as an acknowledgment, etc.). A response may contain one or more transmissions that are separately verifiable (e.g., using a CRC check).

The control of time-out periods may be implemented in any feasible manner (e.g., a hardware counter, a software counter, etc.). The illustrated embodiment of FIG. 2 shows timeout periods that begin immediately after the AP transmissions and that are controlled by the AP. Other embodiments may use other techniques (e.g., the timeout periods may start a predetermined time period after the start or end of the transmissions, the timeout periods may be controlled by the STAs, etc.).

In the illustrated embodiment of FIG. 2, each of the transmissions to STA1 and STA2 contain a poll, while only one contains data, but other embodiments may use other techniques. For example: 1) all, some, or none of the transmissions from the AP may contain a poll, 2) all, some, or none of the transmissions from the AP may contain data, 3) all, some, or none of the transmissions from the AP may contain a training request, 4) etc. In various embodiments, any transmissions from the AP to the STAs that have different lengths and that expect acknowledgments from the STAs may use the techniques described herein.

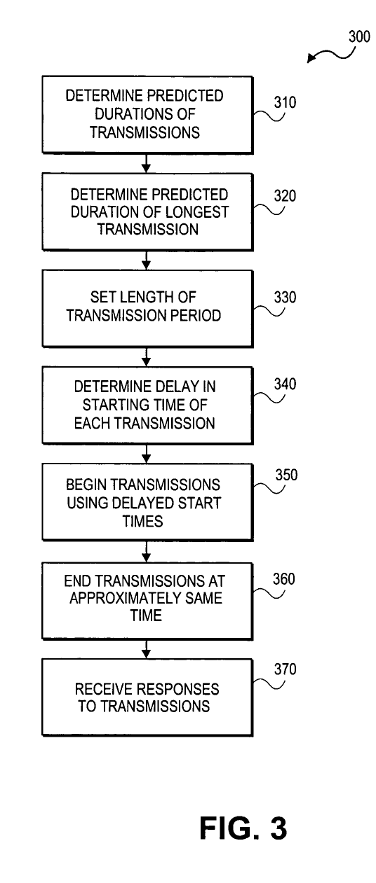

FIG. 3 shows a flow chart of a method of adjusting transmissions to end at approximately the same time, according to an embodiment of the invention. In flow chart 300, at 310 indicators of the predicted durations of the transmissions to be transmitted substantially simultaneously may be determined. At the time of determination, the transmissions may not have started and so the determined durations may be referred to as predicted durations. Such indicators may be determined in any feasible units, e.g., time, bytes, clock cycles, etc., that provide indicators with a common basis so that the indicators may be compared to determine how to adjust start times so the transmissions may end at approximately the same time. If the different transmissions are to have different data rates, the data rates may be a factor in determining the predicted durations of the transmissions. In some embodiments, the time period allotted for transmissions (e.g., t₁ in FIG. 2) may be determined based on the anticipated duration of the longest transmission, in which case the anticipated duration of the longest transmission may be determined at 320 and the length of the transmission period set at 330. In other embodiments, the time period allotted for transmission may be fixed or may be set by other parameters not described here. At 340, a start delay may be calculated for each of the various transmissions, so that if the start of each transmission is delayed by its associated delay time, all the transmissions will end at approximately the same time. The start delay times may be measured from any feasible common reference point. At 350, the actual transmissions may be started, using the indicated delays in their start times so that the transmissions end at approximately the same time at 360. Upon receiving the transmissions, the mobile devices may each respond, and the responses may be received at 370.

In some embodiments that allot a fixed time for transmission, the described process may include calculating and using a delay time for the longest transmission. In some embodiments that match the time allotted for transmission to the length of the longest transmission, calculating and using a delay time for the longest transmission may be eliminated.

Returning to FIG. 2, during time period t₂, STA1 and STA2 may transmit responses to the AP substantially simultaneously. In the illustrated embodiment, these responses each include data and an acknowledgment to the respective poll, but other embodiments may produce other types of responses. For example: 1) all, some, or none of the response from a particular STA may contain an acknowledgment, 2) all, some, or none of the response from a particular STA may contain data, 3) the existence of any correctly received response may be interpreted as an acknowledgment, 4) etc.

During time period t₃, after all STAs have finished transmitting, the AP may individually acknowledge these responses substantially simultaneously, as shown. ACK1 is shown as the acknowledgment to the response from STA1, while ACK2 is shown as the acknowledgment to the response from STA2. If a given STA does not receive an acknowledgment within a defined time period, it may assume the response was not correctly received by the AP and may re-transmit the response when polled again. Various techniques may be used to set this defined time period.

Between the time periods t₁, t₂, and t₃, the embodiment of FIG. 2 shows an interframe space (IFS). Various embodiments may use such time intervals in all, some, or none of the indicated places. The IFSs may have uniform duration, or may have different durations according to various criteria. These time intervals may serve various purposes, for example: 1) to allow for differences in the timing of the AP and various STAs, 2) to allow a time for any needed processing between transmissions and receptions, 3) to allow time for a transceiver to switch between transmit and receive modes, 4) etc.

In some embodiments, the delays in starting times for the transmissions from the base station may be calculated from the interframe space immediately preceding the transmissions. In other embodiments, the delays in starting times for all but the longest transmission may be calculated from the start of the longest transmission.

Various embodiments of the invention may be implemented in one or a combination of hardware, firmware, and software. Embodiments of the invention may also be implemented as instructions stored on a machine-readable medium, which may be read and executed by a computing platform to perform the operations described herein, for example those operations described in FIGS. 2 and 3 and the associated text. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

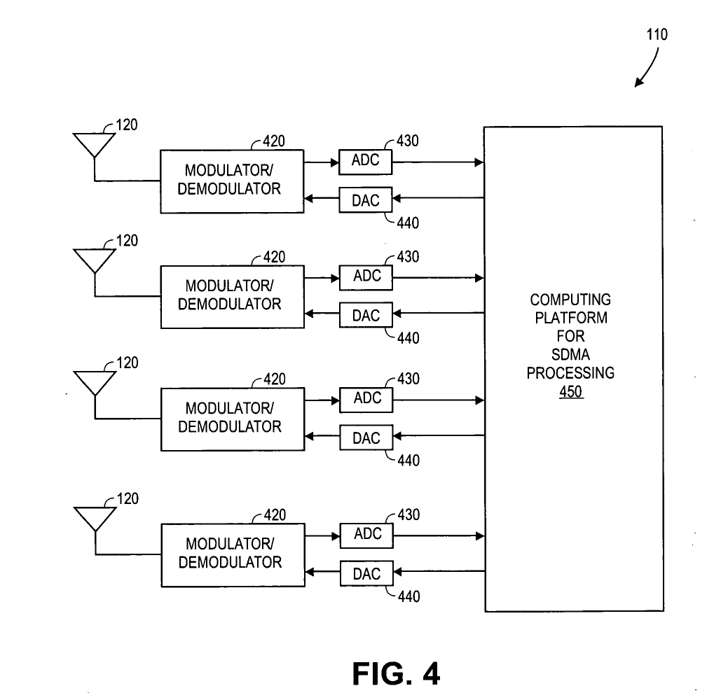

FIG. 4 shows a block diagram of a base station, according to an embodiment of the invention. Computing platform 450 may include one or more processors, and in some embodiments at least one of the one or more processors may be a digital signal processor (DSP). In the illustrated embodiment, AP 110 has four antennas 120, but other embodiments may have two, three, or more than four antennas. For each antenna, base station 110 may have a modulator/demodulator 420, an analog-to-digital converter (ADC) 430, and a digital-to-analog converter (DAC) 440. The combination of demodulator-ADC may convert received radio frequency signals from the antenna into digital signals suitable for processing by the computing platform 450. Similarly, the combination of DAC-modulator may convert digital signals from the computing platform 450 into radio frequency signals suitable for transmission through an antenna. Other components not shown may be included in the illustrated blocks as needed, such as but not limited to amplifiers, filters, oscillators, etc.

The foregoing description is intended to be illustrative and not limiting. Variations may occur to those of skill in the art. Those variations are intended to be included in the various embodiments of the invention, which are limited only by the spirit and scope of the appended claims.

1. An apparatus, comprising:
a first electronic device adapted to
compare a first indicator of a predicted duration of a first transmission to a second electronic device with a second indicator of a predicted duration of a second transmission to a third electronic device;
adjust starting times of at least one of the first and second transmissions to cause the first and second transmissions to end at approximately a same time; and
transmit the first and second transmissions using the adjusted starting times.

2. The apparatus of claim 1, wherein the first electronic device is further adapted to receive a first response comprising a first acknowledgment to the first transmission from the second electronic device and to receive a second response comprising a second acknowledgment to the second transmission from a third electronic device.

3. The apparatus of claim 1, wherein the first electronic device is further adapted to include a poll in the first transmission and to include a poll and other data in the second transmission.

4. The apparatus of claim 1, wherein the first electronic device is further adapted to set a transmission period for the first and second transmissions based on a longer of the predicted durations of the first and second transmissions.

5. The apparatus of claim 1, wherein:
the first transmission and the second transmission are to have different data rates; and
the predicted durations of the first and second transmissions are partly based on the different data rates.

6. The apparatus of claim 1, wherein the first electronic device comprises a computing platform to perform said comparing.

7. The apparatus of claim 6, further comprising at least four modulator/demodulators coupled to the computing platform.

8. The apparatus of claim 7, further comprising at least four antennas, each of the at least four antennas coupled to at least one of the at least four modulator/demodulators.

9. The apparatus of claim 1, wherein the first electronic device comprises a base station.

10. The apparatus of claim 1, wherein the second and third electronic devices comprise mobile devices.

11. The apparatus of claim 1, wherein the first electronic device is further adapted to transmit the first and second transmissions using spatial division multiple access techniques.

12. A method, comprising:
making a comparison of a first indicator of a predicted duration of a first transmission to a first electronic device with a second indicator of a predicted duration of a second transmission to a second electronic device;
beginning a transmission of a longer of the first and second transmissions; and
beginning a transmission of a shorter of the first and second transmissions after a delay approximately equal to a difference between the predicted duration of the first transmission and the predicted duration of the second transmission;
wherein the first and second transmissions use spatial division multiple access techniques.

13. The method of claim 12, further comprising ending the first and second transmissions at approximately a same time.

14. The method of claim 13, further comprising beginning an acknowledgment timeout period after said ending the first and second transmissions.

15. The method of claim 12, further comprising receiving a first response from the first electronic device and receiving a second response from the second electronic device substantially simultaneously.

16. The method of claim 15, wherein said receiving the first and second responses comprises receiving a beginning of the first and second responses approximately an interframe space after an end of the first and second transmissions.

17. The method of claim 12, further comprising using data rates to determine the predicted durations.

18. A machine-readable medium that provides instructions, which when executed by a processing platform, cause said processing platform to perform operations comprising:
determining predicted durations of multiple transmissions to be transmitted from an electronic device;
adjusting start times for at least some of the transmissions to cause the multiple transmissions to end at approximately a same time; and
transmitting the multiple transmissions substantially simultaneously using the adjusted start times and using spatial division multiple access techniques.

19. The medium of claim 18, wherein said determining comprises using data rates to determine said predicted durations.

20. The medium of claim 18, wherein the operations further comprise receiving responses to the multiple transmissions substantially simultaneously.

21. The medium of claim 20, wherein the operations further comprise initiating a timeout period for reception of an acknowledgment to at least one of the multiple transmissions.

22. The medium of claim 20, wherein said receiving comprises receiving beginnings of the responses approximately an interframe space after an end of the multiple transmissions.
